(19) United States
(12) Patent Application Publication
(10) Pub. No.: US 2020/0341443 A1
(43) Pub. Date: Oct. 29, 2020

(54) CONTROL DEVICE, HOME APPLIANCE, COMMUNICATION DEVICE, SERVER, INFORMATION PRESENTATION SYSTEM, NON-TRANSITORY COMPUTER READABLE MEDIUM, AND CONTROL METHOD

(71) Applicant: SHARP KABUSHIKI KAISHA, Sakai City (JP)

(72) Inventors: HIROAKI TANAKA, Sakai City (JP); TADAO ANDOH, Sakai City (JP); TAKUYA OYAIZU, Sakai City (JP)

(21) Appl. No.: 16/809,107

(22) Filed: Mar. 4, 2020

(30) Foreign Application Priority Data
Apr. 26, 2019 (JP) 2019-086590

(51) Int. Cl. G05B 19/042; G05B 13/02

(52) U.S. Cl. CPC G05B 19/0423; G05B 2219/2642; G05B 2219/25274; G05B 13/026

(57) ABSTRACT

A control device is configured to control an information presentation system including at least one home appliance having a communication function and a plurality of communication devices. The control device includes: a behavior prediction unit configured to perform behavior prediction processing to predict a behavior using the at least one home appliance of a subject user on the basis of operation information and an operation history of the at least one home appliance; and a suggestion information processing unit configured to perform suggestion information processing to generate suggestion information useful for the subject user to perform the behavior predicted by the behavior prediction unit such that the suggestion information is presented to the subject user using a subject communication device.

### CROSS-REFERENCE TO RELATED APPLICATIONS

This application claims the benefit, of priority to Japanese Patent Application Number 2019-086590 filed on Apr. 26, 2019. The entire contents of the above-identified application are hereby incorporated by reference.

### BACKGROUND

### Technical Field

The disclosure relates to a control device, a home appliance, a communication device, a server, an information presentation system, a non-transitory computer readable mediums, and a control method.

In the related art, a technique for presenting information reflecting user preferences and the like on a communication terminal associated with a server by uploading information representing an operation of a home appliance having a communication function and information representing a state of the home appliance to a server has been researched and developed.

JP 2004-185612A (published on Jul. 2, 2004), for example, discloses an operation history use system in which a terminal home appliance, a server home appliance, and an application server are connected to each other using a network.

In this system, the terminal home appliance is equipped with a device agent that records, as an operation history, a set of an apparatus operated by a user, an operation content, and the like. The server home appliance is also equipped with a user agent that receives the operation history from the device agent to centrally manage the operation history. In addition, the application server is equipped with a service concierge that provides services in consideration of user preferences and the like by inquiring about. the operation history to the user agent.

### SUMMARY

However, the operation history use system disclosed in JP 2004-185612A (published on Jul. 2, 2004) does not mean that, when there are a plurality of users who are service provision destinations, the operation history use system determines whether a user is one who has actually operated the terminal home appliance and then provides the services only to the user.

As a result, there is a problem that services that match only preferences of a specific user are uniformly provided to all of the plurality of users, leading to wasteful provision of services.

One aspect of the disclosure has been made in view of the problem described above, and an objective thereof is to improve the convenience for a user who receives a service such that the service is provided only to the user who has actually operated a terminal home appliance in consideration of preferences of the user.

In order to solve the problem, a control device according to an aspect of the disclosure is a control device configured to control an information presentation system including at least one home appliance having a communication function and a plurality of communication devices, the control device including a behavior prediction unit configured to perform behavior prediction processing to predict a behavior using the at least one home appliance of a subject user who is a user of one of the plurality of communication devices operating the at least one home appliance on the basis of operation information representing an operation content of an operation received by the at least one home appliance and an operation history of the at least one horse appliance accumulated for each user of the plurality of communication devices, and a suggestion information processing unit. that performs suggestion information processing to generate suggestion information useful for the subject user to perform the behavior predicted by the behavior prediction unit such that the suggestion information is presented to the subject user using a subject communication device carried by the subject user among the plurality of communication devices.

In order to solve the problem, a home appliance according an aspect he disclosure is a home appliance having a communication function communicating with at least one of a plurality of communication devices to configure an information presentation system, in which at least one control device is mounted in the home appliance, and the at least one control device performs behavior prediction processing to predict a behavior using the home appliance of a subject user who is a user of one of the plurality of communication devices operating the home appliance on the basis of operation information representing an operation content of an operation received by the home appliance and an operation history of the home appliance accumulated for each user of the plurality of communication devices, and suggestion information processing to generate suggestion information useful for the subject user to perform the behavior predicted in the behavior prediction processing such that the suggestion information is presented to the subject user using a subject communication device carried by the subject user among the plurality of communication devices.

In order to solve the problem, a communication device according to an aspect of the disclosure is one of a plurality of communication devices that communicate with at least one home appliance to configure an information presentation system, in which at least one control device is mounted in the communication device, and the at least one control device performs behavior prediction processing to predict a behavior using the at least one home appliance of a subject user who is a user of the communication device operating the at least one home appliance on the basis of operation information representing an operation content of an operation received by the at least one home appliance and an operation history of the at least one home appliance accumulated for each user of the plurality of communication devices, and suggestion information processing to generate suggestion information useful for the subject user to perform the behavior predicted in the behavior prediction processing such that the suggestion information is presented to the subject user using a subject communication device carried by the subject user among the plurality of communication devices.

In order to solve the problem, a server according to an aspect of the disclosure is a server included in a plurality of communication devices that communicate with at least one home appliance to configure an information presentation system, in which at least one control device is mounted in the server, and the at least one control device performs behavior prediction processing to predict a behavior using the at least one home appliance of a subject user who is a user of one of the plurality of communication devices operating the at least one horse appliance on the basis of operation information representing an operation content of an operation received by the at least one home appliance and an operation history of the at least one home appliance accumulated for each user of the plurality of communication devices, and suggestion information processing to generate suggestion information useful for the subject user to perform. the behavior predicted in the behavior prediction processing such that the suggestion information is presented to the subject user using a subject communication device carried by the subject user among the plurality of communication devices.

In order to solve the problem, an information presentation system according to an aspect of the disclosure is an information presentation system that includes at least one home appliance having a communication function and a plurality of communication devices and is controlled by at least one control device, in which the at least one control device performs behavior prediction processing to predict a behavior using the at least one home appliance of a subject user who is a user of one of the plurality cf communication devices operating the at least one home appliance on the basis of operation information representing an operation content of an operation received by the at least one home appliance and an operation history of the at least one horse appliance accumulated for each user of the plurality of communication devices, and suggestion information processing to generate suggestion information useful for the subject user to perform the behavior predicted in the behavior prediction processing such that the suggestion information is presented to the subject user using a subject communication device carried by the subject user among the plurality of communication devices.

In order to solve the problem, a control method according to an aspect of the disclosure is a control method for a control device configured to control an information presentation system including at least one home appliance having a communication function and a plurality of communication devices, the control method including performing behavior prediction processing to predict a behavior using the at least one home appliance of a subject user who is a user of one of the plurality of communication devices operating the at least one home appliance on the basis of operation information representing an operation content of an operation received by the at least one home appliance and an operation history of the at least one home appliance accumulated for each user of the plurality of communication devices, and performing suggestion information processing to generate suggestion information useful for the subject user to perform the behavior predicted in the performing behavior prediction processing such that the suggestion information is presented to the subject user using a subject communication device carried by the subject user among the plurality of communication devices.

According to an aspect of the disclosure, it is possible to improve the convenience for a user who receives presentation of suggestion information in an information presentation system.

### BRIEF DESCRIPTION OF DRAWINGS

The disclosure will be described with reference to the accompanying drawings, wherein like numbers reference like elements.

FIG. 1 is a schematic diagram illustrating an overview of an information presentation system according to an embodiment of the disclosure.

FIG. 2 is a block diagram illustrating a functional configuration of an information presentation system according to an embodiment of the disclosure.

FIG. 3 is a flowchart illustrating a method of presenting suggestion information according to an embodiment of the disclosure.

FIG. 4 is a block diagram illustrating a functional configuration of an example of an information presentation system according to a modified example of the disclosure.

FIG. 5 is a block diagram illustrating a functional configuration of another example of an information presentation system according to a modified example of the disclosure.

### DESCRIPTION OF EMBODIMENTS

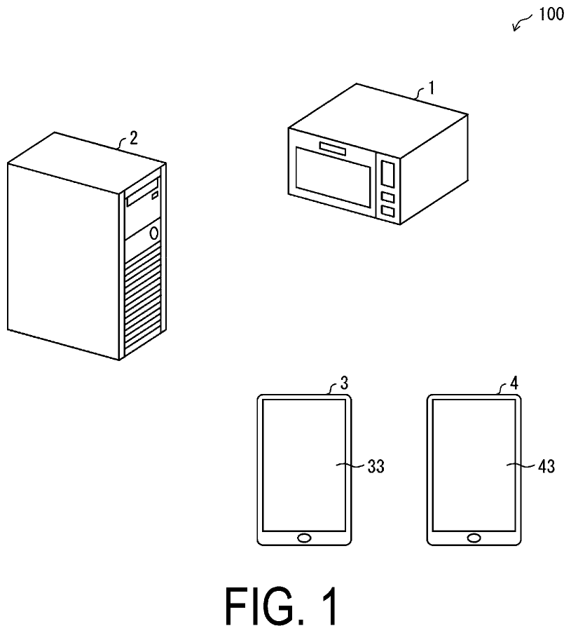

An embodiment of the disclosure will be described in detail with reference to FIG. 1 to FIG. 5.

An information presentation system including one home appliance, one server, and two communication devices will be described below as an information presentation system according to an embodiment of the disclosure.

Note that the number of home appliance and servers configuring the information presentation system according to an aspect of the disclosure may he one or multiple. In addition, the number of communication devices configuring the information presentation system according to an aspect of the disclosure may be two or more. Furthermore, it is assumed that, in the information presentation system according to an aspect of the disclosure, two or more communication devices are carried by different users respectively.

### Overview of Information Presentation System

First, an overview of an information presentation system 100 according to an embodiment of the disclosure will b described with reference to FIG. 1. As illustrated in FIG. 1, the information presentation system 100 includes a home appliance 1, a server 2, a first communication device 3, and a second communication device 4. The information presentation system 100 is a system that presents suggestion information, which will be described below, to a first user who, not illustrated, is a user of the first communication device 3 and a second user who, not illustrated, is a user of the second communication device 4.

The home appliance 1 is, for example, a microwave oven, an air conditioning device (hereinafter referred to as an “air conditioner”), or a refrigerator having a communication function. In the present embodiment, tie home appliance 1 is assumed to be a microwave oven. The server 2 communicates with the home appliance 1, the first communication device 3, and the second communication device 4 to transmit and receive various kinds of information, and stores and manages the received various kinds of information.

The first communication device 3 and the second communication device 4 are, for example, smart phones or tablet terminals, and communicate with the home appliance 1 and the server 2. In the present embodiment, the first communication device 3 and the second communication device 4 are assumed to be smartphones. The first communication device 3 includes a display unit that displays various images, and the second communication device 4 likewise includes a display unit. The display unit of the first communication device 3 is an example of a presentation unit 33 which will be described below, and the display unit of the second communication device 4 is an example of a presentation unit 43 which will be described below.

The information presentation system 100 presents suggestion information, which will be described below, on the communication device carried by a subject user among the first communication device 3 and the second communication device 4 when the first user or the second user operates the home appliance 1. The subject user is the user of the communication device who operates the home appliance 1 among the first user and the second user. In the following description, the communication device carried by the subject user will be referred to as a subject communication device.

Functional Configuration of Home Appliance, Server, First Communication Device, and Second Communication Device

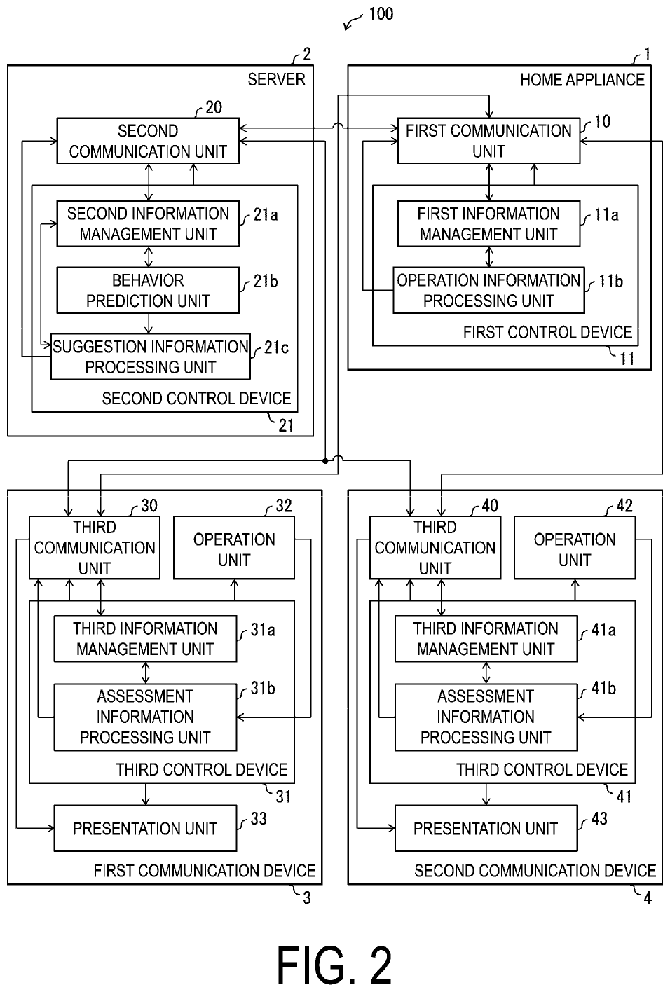

Next, a functional configuration of the home appliance 1, the server 2, the first communication device 3, and the second communication device 4 will be described with reference to FIG. 2. As illustrated in FIG. 2, the home appliance 1 includes a first communication unit 10 and a first control device 11. The first communication unit 10 communicates with a second communication unit 20 and third communication units 30 and 40, both of which will be described later, via an antenna, which is not illustrated.

The first control device 11 is, for example, a CPU, and comprehensively controls each of the devices and units provided in the home appliance 1. This applies also to a second control device 21 and third control devices 31 and 41, both of which will be described below. The first control device 11 includes a first information management unit 11a and an operation information processing unit 11b.

The first information management unit 11a is a ROM, a RAM, and the like, and stores and manages various kinds of information of the home appliance 1. This applies also to a second information management unit 21a and third information management units 31a and 41a, both of which will be described below. The first information management unit 11a transmits and receives various kinds of information to and from the second information management unit 21a and the third information management units 31a and 41a, both of which will be described below, via the first communication unit 10. Details of the operation information processing unit lib will be described below.

As illustrated in FIG. 2, the server 2 includes a second communication unit 20 and a second control device 21. The second communication unit 20 communicates with the first communication unit 10 and the third communication units 30 and 40, which will be described below, via an antenna, which is not illustrated. The second control device 21 includes a second information management unit 21a, a behavior prediction unit 21b, and a suggestion information processing unit 21c.

The second information management unit 21a transmits and receives various kinds of information to and from the first information management unit 11a and the third information management units 31a and 41a, which will be described below, via the second communication unit 20. An operation history of the home appliance 1 used by the first user and the second user is accumulated in the second information management unit 21a, and the accumulated operation history is stored and managed. Details of the behavior prediction unit 21b and the suggestion information processing unit 21c will be described below.

As illustrated in FIG. 2, the first, communication device 3 includes a third communication unit 30, a third control device 31, an operation unit 32, and a presentation unit 33. The third communication unit 30 communicates with the first communication unit 10, the second communication unit 20, and the third communication unit 40 which will be described below, via an antenna, which is not illustrated. The operation unit 32 receives an operation of the first communication device 3.

The presentation unit 33 is a display unit of the first communication device 3 with a touch panel in the present embodiment, and when the first communication device 3 corresponds to the subject communication device, the presentation unit 33 generates an image corresponding to suggestion information received from the suggestion information processing unit 21c of the server 2 via the third communication unit 30 and displays the generated image on the display screen.

The display of the image is an example of a suggestion information presentation process of presenting suggestion information to a subject user.

The third control device 31 includes the third information management unit 31a and an assessment information processing unit 31b. The third information management unit 31a transmits and receives various kinds of information to and from the first information management unit 11a, the second information management unit 21a, and the third information management unit 41a, which will be described below, via the third communication unit 30. Details of the assessment information processing unit 31b will be described below.

As illustrated in FIG. 2, the second communication device 4 includes the third communication unit 40, the third control device 41, an operation unit 42, and a presentation unit 43. Configurations and processing contents of the third communication unit 40, the third control device 41, the operation unit 42, and the presentation unit 43 are similar to those of the third communication unit 30, the third control device 31, the operation unit 32, and the presentation unit 33 of the first communication device 3.

Note that all of the first control device 11, the second control device 21, and the third control devices 31 and 41 are examples of the control device according to an aspect of the disclosure.

Method of Presenting Suggestion Information by Information Presentation System

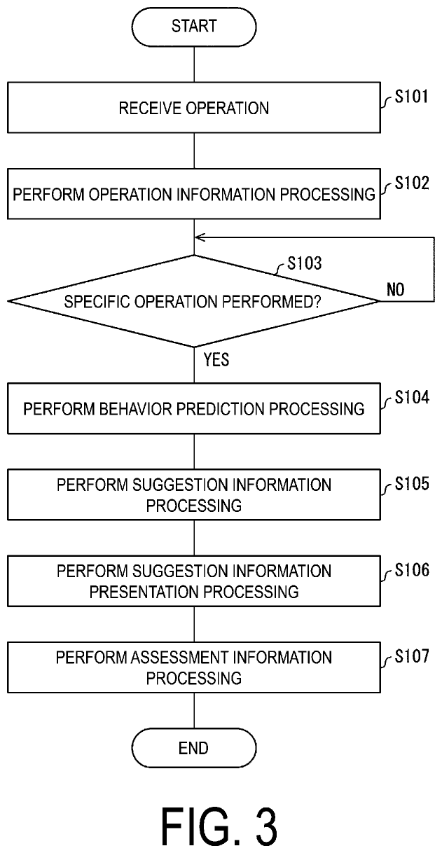

Next, a method of presenting suggestion information by the information presentation system 100 will be described using the flowchart of FIG. 3. Note that, in the following description of the method of presentation, the first user carrying the first communication device 3 is assumed to be operating the home appliance 1. In other words, the first user is assumed to be a subject user.

When an operation unit, which is not illustrated, receives an operation of the first user in the home appliance 1 (S101), the operation unit transmits the operation content of the operation to the first information management unit 11a. The first information management unit 11a that has received the operation content from the operation unit records and manages the operation content of the operation received by the operation unit and transmits the operation content to the operation information processing unit 11b. The operation information processing unit 11b that has received the operation content of the operation from the first information management unit 11a performs an operation information processing (S102). The operation information processing is a process of generating operation information representing the operation content of the operation received by the operation unit of the home appliance 1 and transmitting the generated operation information to the server 2 via the first communication unit 10.

After S102, in the server 2, the second information management unit 21a that has received the operation information via the second communication unit 20 records and manages the received operation information and transmits the operation information to the behavior prediction unit 21b. The behavior prediction unit 21b that has received the operation information detects that a specific action has been performed on at least one of the home appliance and the first communication device 3 (S10).

Here, the “specific action” refers to an action performed by a subject user on the home appliance 1 or a subject communication device with a nigh probability that the home appliance will be used after the end of the action. The “specific action” can include an action of gripping and lifting a subject communication device, an action of opening a door of a microwave oven that is an example of the home appliance 1, and the like. Each of the exemplified actions is detected by, for example, an acceleration sensor, a pressure sensor, which are not illustrated, or the like mounted in the home appliance 1, the first communication device 3, and the second communication device 4.

Note that the processing of S103 may be performed, for example, between processing of S104 and processing of S105, which will be described below, or may be performed between processing of S105 and processing of S106, which will be described below.

If a specific action is detected (S103: YES), the behavior prediction unit 21b performs behavior prediction processing on the basis of the operation information, the operating history of the home appliance 1 read from the second information management unit 21a, and the accumulated assessment information (S104). S104 is an example of a behavior prediction step in which the behavior prediction processing is a process of predicting a behavior of the subject user using the home appliance 1. Details of assessment information will be described below.

The operation history of the home appliance 1 specifically refers to an operation history of the home appliance 1 stored for each of the first user and the second user. in the present embodiment, an operation history of the various buttons for cooking accumulated for each of the first user and the second user corresponds to an operation history of the home appliance 1, for example, because the home appliance 1 is a microwave oven. Note that if the home appliance 1 is an air conditioner, an operating history of a temperature setting button accumulated for each of the first user and the second user, example, is an operation history of the home appliance 1. Also, if the home appliance 1 is a television, for example, an operation history of a channel setting button accumulated for each of the first user and the second user is an operation history of the home appliance 1.

The behavior prediction processing by the behavior prediction unit 21b is performed as follows. First, the behavior prediction unit 21b compares the operation information with the operation history of the first user and the second user and identifies, as a subject user, a user who has made more operations of the same content as that of the operation information (hereinafter, referred to as a “reference operation”) included in the operation history. Next, the behavior prediction unit 21b extracts, from the operation history of the subject user, relevant operations related to the reference operation that were performed within a predetermined period of time before and after the performance time point of the reference operation and counts the number of extractions for each different type of relevant operations.

Next, the behavior prediction unit 21b identifies candidate behaviors that are reasonably supposed from the contents of the reference operation and the contents of a predetermined number of highly ranked relevant operations with a higher number of extractions. Identification of candidate behaviors will be described taking an example in which the first user who is a subject user operates an operation unit of a microwave oven which is an example of the home appliance 1 to input “oven,” “600 W,” and “heating time: approximately 2 to 3 minutes.” In this example, “oven,” “600 W,” and “heating time: approximately 2 to 3 minutes” are reference operations together. In a case where, among a plurality of extracted relevant operations, top five relevant operations with a high number of extractions are input of “hamburger,” “meat-stuffed peppers,” “savory egg custard,” “macaroni gratin,” and “beef croquette,” the behavior prediction unit 21b identifies that the first user is going to cook a meat dish using the home appliance 1 as a candidate behavior because three of these top five relevant operations are operations related to meat dishes.

Next, the behavior prediction unit 21b identifies a correspondence relation between a series of operations including a reference operation and a relevant operation that serves as a specific basis for the candidate behavior and the accumulated assessment information for each of the series of operations in different types. Then, in a case where there are a predetermined number of pieces of assessment information corresponding to the series of operations or more, the assessment information representing positive assessment, the behavior prediction unit 21b determines the candidate behavior to be a behavior for which suggestion information is preferably presented to the subject user and finally predicts that the candidate behavior is a behavior of the subject user using the home appliance 1.

In the above example, assuming that, the standard number of pieces of assessment information representing positive assessment is two, in a case where the assessment of all of assessment information corresponding to a series of operations including a reference operation and an input of “hamburger,” assessment information corresponding to a series of operations including a reference operation and an input of “meat-stuffed peppers,” and assessment information corresponding to a series of operations including a reference operation and an input of “beef croquette” is positive, the behavior prediction unit 21b finally predicts the candidate action “cooking a meat dish using the home appliance 1” as a behavior of the subject user using the home appliance 1.

On the other hand, if there are a smaller number of pieces of assessment information representing positive assessment than the predetermined number, the behavior prediction unit 21b determines the candidate behavior to be a behavior for which suggestion information may not be presented to the subject user. In this case, the processes from S105 are not performed. The word “positive” will be described below.

The behavior prediction unit 21b transmits information about the candidate behavior predicted as a behavior of the subject user using the home appliance 1 to the suggestion information processing unit 21c after performing the behavior prediction process. On the other hand, if no specific action is detected (S103: NO), the behavior prediction unit 21b performs the process of S103 again.

After S104, the suggestion information processing unit 21c that has received the prediction result from the behavior prediction unit 21b performs suggestion information processing (S105). The suggestion information processing is processing to generate suggestion information such that the suggestion information is presented to the subject user by means of the subject communication device and to transmit the generated suggestion information to the subject communication device. In the example of the flowchart of FIG. 3, the suggestion information processing unit 21c generates suggestion information such that the suggestion information is presented to the first user by means of the first communication device 3 and transmits the generated suggestion information to the first communication device 3. The suggestion information is information useful for the subject user to perform a behavior predicted by the behavior prediction unit 21b.

Here, “useful information” refers to information that enables, when the information is presented while a behavior is performed using the home appliance 1, the subject user to easily perform the behavior that matches his or her habits or preferences related to the use of the home appliance 1 or behavior of the subject user to be promoted. In the present embodiment, because the home appliance 1 is a microwave oven, for example, if either the first user or the second user preferably cooks a meat dish. the recipe for the meat dish is “useful information” for the user. Also, for example, if the home appliance 1 is a television, a list of television programs in the genre that either the first user or the second user preferentially watches is “useful information” for the user.

The suggestion information processing by the suggestion information processing unit 21c is performed as follows. First, the suggestion information processing unit 21c analyzes the content of assessment information corresponding to the suggestion information presented when a similar behavior to a behavior predicted by the behavior prediction unit 21b was performed in the past. Then, if the number of pieces of assessment information with positive content is greater than or equal to a predetermined value, the suggestion information processing unit 21c generates suggestion information and transmits the suggestion information to the first communication device 3. That is, even if the behavior prediction unit 21b predicts the behavior of the first user, in other words, the subject user, the suggestion information is not necessarily presented to the first user. As a result, the first user is not wastefully presented with suggestion information that is hard to feel useful, and the first communication device 3 can be operated and used smoothly. Note that the meaning of the word “positive” will be described later.

The suggestion information processing unit 21c does not transmit the suggestion information to the second communication device 4, in other words, to a communication device not serving as a subject communication device. As a result, because the suggestion information is not presented to the second user, in other words, the user who is not a subject user, the second user is not wastefully presented with the suggestion information that is little related to him or her, and the second communication device 4 can be operated and used smoothly.

After S105, the presentation unit 33 performs a suggestion information presentation process on the basis of the suggestion information received from suggestion information processing unit 21c via the third communication unit 30 (S106). S106 is an example of a suggestion information processing step. In the example of the “useful information” described above, if the behavior of the first user predicted by the behavior prediction unit 21b is cooking a meat dish, the presentation unit 33 generates an image representing the recipe for the meat dish and displays the image on a display screen. In addition, when the behavior of the first user predicted by the behavior prediction unit 21b is watching a television program, the presentation unit 33 generates an image representing a list of television programs in the genre that the first user preferentially watches and displays the image on the display screen.

After S106, the assessment information processing unit 31b performs an assessment information processing (S107). The assessment information processing is to generate assessment information by receiving, with the operation unit 32 or 42, an operation of inputting the assessment of the subject user with respect to the suggestion information presented by the presentation unit 33 or 43. In addition, the process includes a series of processes of transmitting the generated assessment information to the behavior prediction unit 21b via the third communication unit 30 or 40. In the example of the flowchart of. FIG. 3, the assessment information processing unit 31b generates assessment information by receiving, with the operation unit 32, the operation of inputting the assessment of the subject user with respect to the suggestion information presented by the presentation unit 33, and transmits the generated assessment information to the behavior prediction unit 21b via the third communication unit 30. The assessment information is information representing the content of the assessment of the subject user with respect to the suggestion information presented by the presentation unit 33 or 43.

For example, an image displayed as “GOOD/BAD” may be displayed on the display screen of the presentation unit 33. In this case, when the first user touches or hovers the portion of the display screen on which “GOOD” of the image is being displayed, assessment information (for example, a point with “+1”) representing positive assessment on the suggestion information presented by the presentation unit 33 is generated. “Positive” in the present specification refers to a case in which the subject user feels that the presented suggestion information was helpful or a good reference. On the other hand, “negative” refers to a case in which the subject user feels that the presented suggestion information was less helpful or the presentation hindered the operation or use of the subject communication device.

The behavior prediction unit 21b that has received the assessment information of the first user from the assessment information processing unit 31b via the second communication unit 20 and the second information management unit 21a accumulates, stores, and manages the received assessment information in a memory, which is not. illustrated. Note that the behavior prediction unit 21b does not necessarily need to accumulate, store, and manage the assessment information, and the second information management unit 21a, example, may accumulate, store, and manage the assessment information. Each of the processes from S101 to S107 described above is performed, and thereby the presentation of the suggestion information by information presentation system 100 is completed.

### MODIFIED EXAMPLE

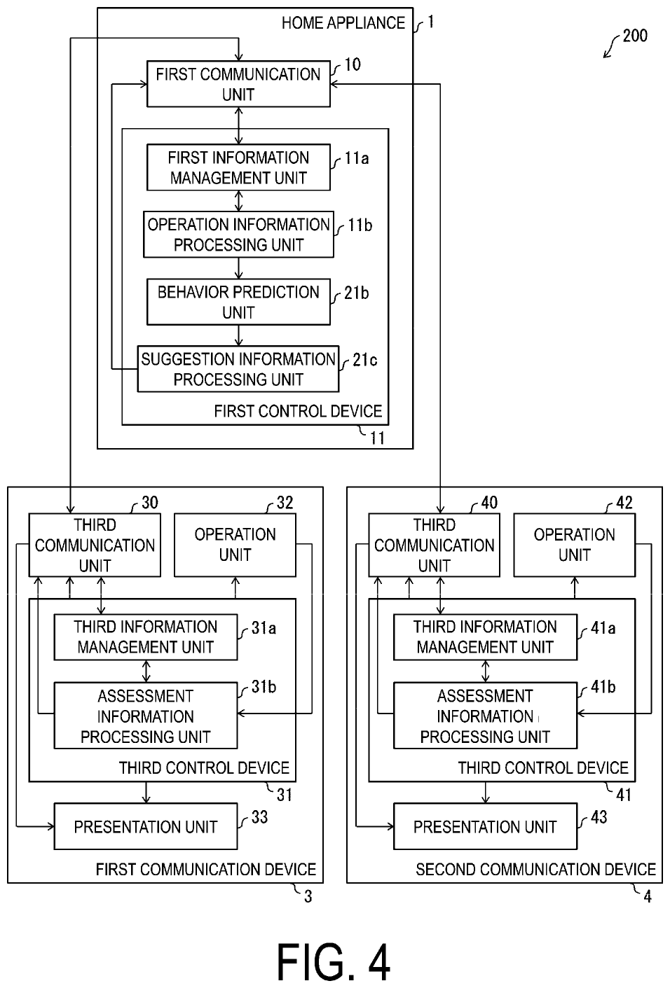

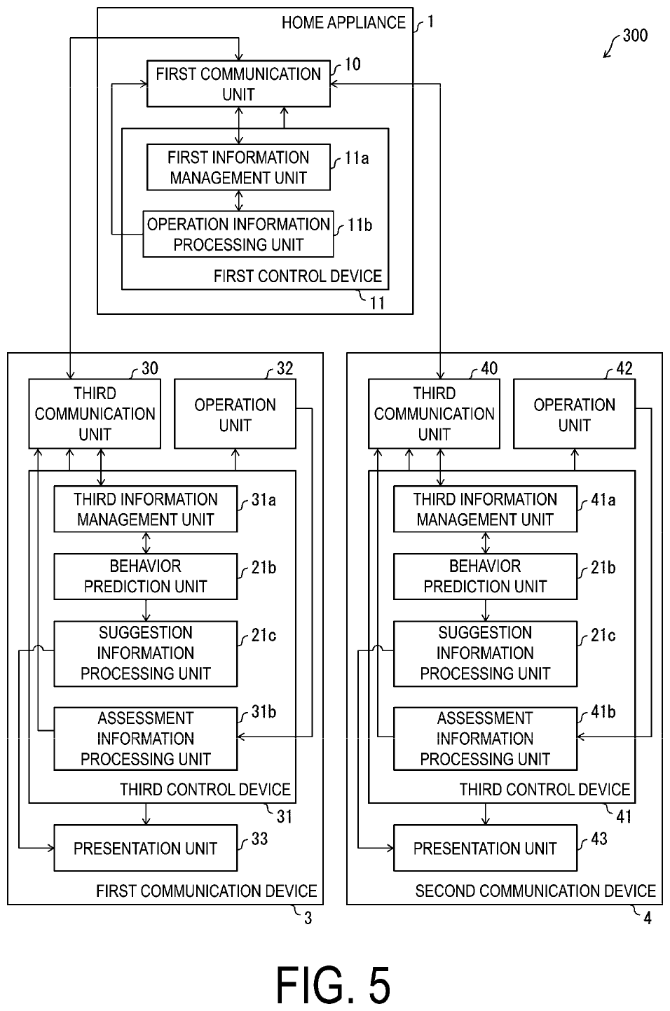

Next, a modified example of the information presentation system 100 according to an embodiment of the disclosure will be described using FIG. 4 and FIG. 5. First, in an information presentation system according to an aspect of the disclosure, a behavior prediction unit 21b and a suggestion information processing unit 21c may not be provided in a second control device 21 of a server 2 as illustrated in FIG. 4 and FIG. 5.

For example, a first control device 11 of a home appliance 1 may be provided with the behavior prediction unit 21b and the suggestion information processing unit 21c. In other words, as illustrated in FIG. 4, an information presentation system 200 including a home appliance 1 provided with a behavior prediction unit 21b and a suggestion information processing unit 21c in a first control device 11 is assumed as a modified example of the information presentation system 100.

In the case of the modified example illustrated in FIG. 4, main processing, that is, behavior prediction processing and suggestion information processing of the server 2 of the information presentation system 100, is executed on the home appliance 1, and thus the server 2 is not necessary as a constituent component of the information presentation system 200. Thus, the server 2 is not included in the constituent components of the information presentation system 200.

For example, the behavior prediction unit 21b and the suggestion information processing unit 21c may be provided in each of the third control devices 31 and 41 of the first and second communication devices 3 and 4. In other words, as illustrated in FIG. 5, an information presentation system 300 including a first and second communication devices 3 and 4 provided with a behavior prediction unit 21b and a suggestion information processing unit 21c in each of the third control devices 31 and 41 is also assumed as a modified example of the information presentation system 100.

In the case of the modified example illustrated in FIG. 5, main processing, that is, behavior prediction processing and suggestion information processing of a server 2 of the information presentation system 100, is executed in the first and the second communication devices 3 and 4, and thus the server 2 is not necessary as a constituent component of the information presentation system 300. Thus, the server 2 is not included in the constituent components of the information presentation system 300.

In other words, an information presentation system according to an aspect of the disclosure may include at least one home appliance having a communication function and a plurality of communication devices, and may be controlled by at least one control device that performs the behavior prediction processing and the suggestion information processing. The “plurality of communication devices” include a server, in addition to a terminal device such as a smart phone or a tablet terminal. Also, the “at least one control device” may be mounted in a home appliance or any one of the plurality of communication devices or may be mounted on neither a home appliance nor the plurality of communication devices.

Next, in the information presentation system 100 according to an embodiment of the disclosure, each of the presentation units 33 and 43 of the first and second communication devices 3 and 4 may be a speaker, which is not illustrated. Alternatively, either of the presentation units 33 and 43 may be a speaker and the other may be a display unit.

In this modified example, for example, third control devices 31 and 41 may include an uttered sentence generation unit, which is not illustrated, that receives suggestion information and generates an uttered sentence representing the content of the suggestion information, and the content of the uttered sentence generated by the uttered sentence generation unit may be output in the form of sound from the speaker served by the presentation unit 33 and/or 43. The above likewise applies to the information presentation systems 200 and 300 according to the modified examples of the embodiment of the disclosure.

In other words, the communication devices configuring the information presentation system according to an aspect of the disclosure may present, a subject user, suggestion information received from the control device that performs the behavior prediction processing and the suggestion information processing in the suggestion information presentation process using any method.

Next, in the information presentation system 100 according to the embodiment of the disclosure, the second control device 21 of the server 2, specifically the behavior prediction unit 21b of the second control device 21, may not perform the process of S103 (detection of specific operations) in the flowchart of FIG. 3. In a modified example, the second control device 21 of the server 2 performs the behavior prediction processing and the suggestion information processing immediately upon receiving operation information from the operation information processing unit 11b of the home appliance 1. Further, in the information presentation system 100, the third control devices 31 and 41 of the first and the second communication devices 3 and 4 may not include the assessment information processing units 31b and 41b. In this modified example, the second control device 21 of the server 2 performs the behavior prediction processing on the basis of the operation information and the operation history. The above likewise applies to the information presentation systems 200 and 300 according to the modified examples of the embodiment of the disclosure.

In other words, the information presentation system according to one aspect of the disclosure may present suggestion information to a subject user by performing at least the behavior prediction process and the suggestion information processing.

Next, in the information presentation system 100 according to the embodiment of the disclosure, the second control device 21 of the server 2, specifically the behavior prediction unit 21b of the second control device 21, may infer changes in a behavior of the subject user on the basis of the operation information and the operation history during the execution of the behavior prediction processing. In this modified example, the behavior prediction unit 21b predicts a behavior of the subject user using the home appliance 1 to improve a concern by matching the concern assumed to be the inferred change of the behavior.

Specifically, the behavior prediction unit 21b identifies the time or the like at which the subject user operated the home appliance 1 from the operation information and compares a plurality of reference operations in the operation history with the time or the like at which the reference operation has been performed. The behavior prediction unit 21b also identifies the period from the operation of the subject user from which the operation information was generated to the reference operation performed just before the operation.

For example, in a case where the operation time of the operation of the subject user from which the operation information was generated is earlier for a predetermined period of time or longer than the operation time of the plurality of reference operations, the behavior prediction unit 21b infers that the subject user has intentionally operated the home appliance 1 earlier than usual. Here, the memory of the behavior prediction unit. 21b or the second information management unit 21a stores the user's concerns in a data table format, and the behavior prediction unit 21b selects a concern reasonably supposed from a change of the inferred behavior of the subject user from the data table. The data table may be a data table listed with concerns common to the first user and the second user or may be a data table listed with different concerns for the first user and the second user.

A “concern” refers to a matter which the first user and the second user are troubled with on their daily lives and can be improved by the users' own behaviors. Concerns can include “time excess/time shortage,” “hot/cold,” “fatigue,” “obesity,” “household chore,” and the like.

In a case where the inputs of an operation of the subject user and a reference operation from which the operation information was generated are “oven,” “600 W,” and “heating time: approximately 2 to 3 minutes,” the behavior prediction unit 21b supposes that the reason that the subject user intentionally operated the home appliance 1 earlier than usual is time excess of the subject user and selects “time excess” from the data table.

Then, the behavior prediction unit 21b predicts a behavior of using the home appliance 1 to solve the concern “time excess.” In this case, the behavior prediction unit 21b predicts that the subject user may perform cooking for a long period of time using the home appliance 1 because a long cooking time can be ensured. The suggestion information processing unit 21c that has received the result of the prediction generates a list cooking recipes that take a long period of time, for example, as suggestion information.

Also, for example, in a case where the period from the operation of the subject user from which the operation information was generated to the reference operation performed just before the operation is longer than or equal to a predetermined period of time, the behavior prediction unit 21b infers that the subject user intentionally has not performed a behavior using the home appliance 1 for a period of time. In the example of the inputs “oven,” “600 W,” and “heating time: approximately 2 to 3 minutes,” the behavior prediction unit 21b supposes that the reason that the subject user intentionally has not performed cooking using the home appliance 1 for a period of time is that the subject user feels cooking annoying and selects “household chore” from the data table.

Then, the behavior prediction unit 21b predicts a behavior of using the home appliance 1 to solve the concern “household chore.” In this case, the behavior prediction unit 21b predicts that the subject user may use the home appliance 1 to cook a simple cuisine because the subject user can cook a simple cuisine without feeling cooking annoying. The suggestion information processing unit 21c that has received the result of the prediction generates a list of recipes of cuisines, for example, easy-to-cook cuisines, as suggestion information. The behavior prediction processing of the behavior prediction unit 21b and the suggestion information processing of the suggestion information processing unit 21c described above can also be applied to the information presentation systems 200 and 300 according he modified examples of the embodiment of the disclosure.

### Implementation Example by Software

A control block (in particular, the behavior prediction unit 21b and the suggestion information processing unit 21c) of the second control device 21 according to the embodiment may be realized by a logic circuit (hardware) formed of an integrated circuit (IC chip) and the like, or by software.

In the latter case, the second control device 21 includes a computer that executes commands of a program that is software for realizing functions. The computer includes, for example, at least one processor (control device) and includes at least one computer-readable recording medium storing the program. Then, the computer achieves the objective of the disclosure due to the processor reading the program from the recording medium and executing the program.

For example, a central processing unit (CPU) can be used as the processor. As the recording medium, a “non-transitory tangible medium,” for example, a tape, a disk, a card, a semiconductor memory, and a programmable logic circuit may be used, in addition to a read only memory (ROM). In addition, a random access memory (RAM) in which the program is loaded may be further included. Further, the program may be supplied to the computer via any transmission medium (a communication network, a broadcast wave, or the like) capable of transmitting the program. Note that an aspect of the disclosure may be implemented in a form of data signals embedded in a carrier wave, which is embodied by electronic transmission of the program.

### Supplement

A control device (the second control device 21) according to a first aspect of the disclosure is a control device configured to control an information presentation system (100, 200, 300) including at least one home appliance (1) having a communication function and a plurality of communication devices (the first communication device 3 and the second communication device 4), the control device including a behavior prediction unit (21b) configured to perform behavior prediction processing to predict a behavior using the at least one home appliance of a subject user who is a user of one of the plurality of communication devices operating the at least, one home appliance on the basis of operation information representing the operation content of an operation received by the at least one home appliance and an operation history of the at least one home appliance accumulated for each user of the plurality of communication devices, and a suggestion information processing unit (21c) configured to perform suggestion information processing to generate suggestion information useful for the subject user to performs the behavior predicted by the behavior prediction unit such that the suggestion information is presented to the subject user using a subject communication device

(the first communication device 3 or the second communication device 4) carried by the subject user among the plurality of communication devices.

According to the above-described configuration, the suggestion information is presented using the subject communication device carried by the subject user among the plurality of communication devices, and the suggestion information is not presented to a communication device carried by a user other than the subject user. Thus, the presentation of the suggestion information enables the subject user to use the home appliance in accordance with his or her habits or preferences, and unnecessary presentation of the suggestion information is not given. to a user other than the subject user. Consequently, users' convenience for having the presentation of the suggestion information can he improved by the information presentation system.

According to the control device according to a second aspect of the disclosure in the first aspect, the subject communication device includes an assessment information processing unit (31b or 41b) configured to generate assessment information representing a content of assessment of the subject user by receiving the assessment of the subject user with respect to the suggestion information presented by the subject communication device and performs assessment information processing to transmit the assessment information that is generated to the control device, the behavior prediction unit may accumulate the assessment information for each user of the plurality of communication devices, the assessment information being received from the assessment information processing unit, and perform the behavior prediction processing on the basis of the operation information, the operation history, and the assessment information that is accumulated.

According to the above-described configuration, the behavior prediction unit performs the behavior prediction processing in consideration of the contents of the operation information and the operation history in addition to the content of the assessment information. Thus, the behavior prediction unit can determine whether the suggestion information is to be presented by considering the content of the assessment information, and in some cases is not capable of presenting suggestion information even if a behavior of the subject user is predicted. As such, a subject user can be presented with suggestion information in a timely manner, so the home appliance can be more conveniently used.

According to the control device according to a third aspect of the disclosure in the first aspect or the second aspect, the behavior prediction unit may perform the behavior prediction processing in a case where a specific action performed on the at least one home appliance or the subject communication devices is detected.

According to the above-described configuration, processing to be performed from the behavior prediction processing is performed when it is preferred time to present suggestion information to the subject user, for example, when the subject user is holding a smartphone serving as a communication device, or opening a door of a refrigerator serving as a home appliance. As such, because the suggestion information is presented in a timely manner, the subject user can use the home appliance more conveniently, than when the suggestion information is presented with or without a particular action.

A home appliance (1) according to a fourth aspect 4 of the disclosure is a home appliance having a communication function for communicating with at least one of the plurality of communication devices (the first communication device 3 and the second communication device 4) to configure the information presentation system (200), in which at least one control device (the first control device 11) is mounted in the home appliance, and the at least one control device performs behavior prediction processing to predict a behavior using the home appliance of a subject user who is a user of one of the plurality of communication devices operating the home appliance on the basis of operation information representing an operation content of an operation received by the home appliance and an operation history of the home appliance accumulated for each user of the plurality of communication devices and suggestion information processing to generate suggestion information useful for the subject user to performs the behavior predicted in the behavior prediction processing such that the suggestion information is presented to the subject user using a subject communication device

(the first communication device 3 or the second communication device 4) carried by the subject user among the plurality of communication devices. According to the above-described configuration, a home appliance exhibiting effects similar to those of the control device according to the first aspect of the disclosure can be realized.

A communication device (the first communication device 3 or the second communication device 4) according to a fifth aspect of the disclosure is one of a plurality of communication devices that communicates with at least one horse appliance (1) to configure the information presentation system (300), in which at least one control device (the third control device 31 or 41) is mounted in the communication device, and the at least one control device performs behavior prediction processing to predict a behavior using the at least one home appliance of a subject user who is a user of the communication device operating the at least one home appliance on the basis of operation information representing an operation content of an operation received by the at least one home appliance and an operation history of the at least one home appliance accumulated for each user of the plurality of communication devices and suggestion information processing to generate suggestion information useful for the subject user to perform the behavior predicted in the behavior prediction processing such that the suggestion information is presented to the subject user using a subject communication device

(the first communication device 3 or the second communication device 4) carried by the subject user among the plurality of communication devices. According to the above-described configuration, a communication device exhibiting effects similar to those of the control device according to the first aspect of the disclosure can be realized.

A server (2) according to a sixth aspect of the disclosure is a server included in a plurality of communication devices (the first communication device 3 and the second communication device 4) that communicate with at least one home appliance (1) to configure the information presentation system (100), in which at least one control device (the second control device 21) is mounted in the server, and the at least one control device performs behavior prediction processing to predict a behavior using the at least one home appliance of a subject user who is a user of one of the plurality of communication devices operating the at least one home appliance on the basis of operation information representing an operation content of an operation received by the at least one home appliance and an operation history of the at least one home appliance accumulated for each user of the plurality of communication devices and suggestion information processing to generate suggestion information useful for the subject user to perform the behavior predicted in the behavior prediction processing such that the suggestion information is presented to the subject user using a subject communication device

(the first communication device 3 or the second communication device 4) carried by the subject user among the plurality of communication devices. According to the above-described configuration, a server exhibiting effects similar to those of the control device according to the first aspect of the disclosure can be realized.

An information presentation system (100, 200, or 300) according to a seventh aspect of the disclosure is an information presentation system including at least one home appliance (1) having a communication function and a plurality of communication devices (the first communication device 3 and the second communication device 4), the information presentation system being controlled by at least one control device (the first control device 11, the second control device 21, or the third control device 31 or 41), in which the at least one control device performs behavior prediction processing to predict a behavior using the at least one home appliance of a subject user who is a user of one of the plurality of communication devices operating the at least one home appliance on the basis of operation information representing an operation content of an operation received by the at least one home appliance and an operation history of the at least one home appliance accumulated for each user of the plurality of communication devices and suggestion information processing to generate suggestion information useful for the subject user to perform the behavior predicted in the behavior prediction processing such that the suggestion information is presented to the subject user using a subject communication device

(the first communication device 3 or the second communication device 4) carried by the subject user among the plurality of communication devices. According to the above-described configuration, the information presentation system exhibiting effects similar to those of the control device according to the first aspect of the disclosure can be realized.

According to the information presentation system (100) according to an eighth aspect of the disclosure, in the seventh aspect, the plurality of communication devices include the server (2) capable of performing transmission and/or reception with the at least one home appliance and the plurality of communication devices, and the at least one control device (the second control device 21) is mounted in the server, and further performs, in the suggestion information processing, processing to transmit the suggestion information that is generated to the subject communication device, the at least one home appliance generates operation information representing the operation content of an operation received by the at least one home appliance and performs operation information processing to transmit the operation information that is generated to the server, and the subject communication device performs suggestion information presentation processing to present the suggestion information received from the at least one control device to the subject user.

According to the above-described configuration, the information presentation system in which the server generates suggestion information on the basis of operation information generated by the home appliance, and the subject communication device receives the suggestion information from the server and presents the suggestion information the subject user can be realized.

A control method according to a ninth aspect of the disclosure is a control method of a control device (the first control device 11, the second control device 21, or the third control device 31 or 41) configured to control an information presentation system (100, 200, 300) including at least one home appliance (1) haying a communication function and a plurality of communication devices (the first communication device 3 and the second communication device 4), the control method including performing behavior prediction processing to predict a behavior using the at least one home appliance of a subject user who is a user of one of the plurality of communication devices operating the at least one home appliance on the basis of operation information representing the content of an operation received by the at least one home appliance and an operation history of the at least one home appliance accumulated for each user of the plurality of communication devices, and performing suggestion information processing to generate suggestion information useful for the subject user to perform the behavior predicted in the performing behavior prediction processing such that the suggestion information is presented to the subject user using a subject communication device

(the first communication device 3 or the second communication device 4) carried by the subject user among the plurality of communication devices. According to the above-described configuration, the control method exhibiting effects similar to those of the control device according to the first aspect of the disclosure can be realized.

The control device according to each aspect of the disclosure may be implemented by a computer, and in this case, a control program for the control device for realizing the control device with the computer by causing the computer to function as each unit (software module) included in the control device and a computer-readable recording medium storing the control program fall within the scope of the disclosure.

### Supplementary Information

The disclosure is not limited to the above-described embodiments and modified examples and can be subject to various modifications within the scope of the claims, and an embodiment obtained by appropriately combining technical elements each disclosed in different embodiments falls also within the technical scope of the disclosure. Furthermore, technical elements disclosed in the respective embodiments may be combined to provide a new technical feature.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. A control device configured to control an information presentation system including at least one home appliance having a communication function and a plurality of communication devices, the control device comprising:
a behavior prediction unit configured to perform behavior prediction processing to predict a behavior using the at least one home appliance of a subject user who is a user of one of the plurality of communication devices operating the at least one home appliance on the basis of operation information representing an operation content of an operation received by the at least one home appliance and an operation history of the at least one home appliance accumulated for each user of the plurality of communication devices; and
a suggestion information processing unit configured to perform suggestion information processing to generate suggestion information useful for the subject user to perform the behavior predicted by the behavior prediction unit such that the suggestion information is presented to the subject user using a subject communication device carried by the subject user among the plurality of communication devices.

2. The control device according to claim 1,
wherein the subject communication device includes an assessment information processing unit configured to generate assessment information representing a content of assessment of the subject user by receiving the assessment of the subject user with respect to the suggestion information presented by the subject communication device and perform assessment information processing to transmit the assessment information that is generated to the control device, and
the behavior prediction unit accumulates the assessment information for each user of the plurality of communication devices, the assessment information being received from she assessment information processing unit, and performs the behavior prediction processing on the basis of the operation information, the operation history, and the assessment information that is accumulated.

3. The control device according to claim 1,
wherein the behavior prediction unit performs the behavior prediction processing in a case where a specific operation performed on the at least one home appliance and/or the subject communication device is detected.

4. A home appliance having a communication function for communicating with at least one of a plurality of communication devices to configure an information presentation system,
wherein at least one control device is mounted in the home appliance, and
the at least one control device performs behavior prediction processing to predict a behavior using the home appliance of a subject user who is a user one of the plurality of communication devices operating the home appliance on the basis of operation information representing an operation content of an operation received by the horse appliance and an operation history of the home appliance accumulated for each user of the plurality of communication devices, and suggestion information processing to generate suggestion information useful for thy, subject user to perform the behavior predicted in the behavior prediction processing such that the suggestion information is presented to the subject user using a subject communication device carried by the subject user among the plurality of communication devices.

5. A communication device that is one of a plurality of communication devices that communicate with at least one home appliance to configure an information presentation system,
wherein at least one control device is mounted in the communication device, and
the at least one control device performs behavior prediction processing to predict a behavior using the at least one home appliance of a subject user who is a user of the communication device operating the at least one horse appliance on the basis of operation information representing an operation content of an operation received by the at least one home appliance and an operation history of the at least one home appliance accumulated for each user of the plurality of communication devices, and suggestion information processing to generate suggestion information useful for the subject user to perform the behavior predicted in the behavior prediction processing such that the suggestion information is presented to the subject user using a subject communication device carried by the subject user among the plurality of communication devices.

6. A server included in a plurality of communication devices that communicate with at least one home appliance to configure an information presentation system,
wherein at least one control device is mounted in the server, and
the at least one control device performs behavior prediction processing to predict a behavior using the at least one home appliance of a subject user who is a user of one of the plurality of communication devices operating the at least one home appliance on the basis of operation information representing an operation content of an operation received by the at least one home appliance and an operation history of the at least one home appliance accumulated for each user of the plurality of communication devices, and suggestion information processing to generate suggestion information useful for the subject user to perform the behavior predicted in the behavior prediction processing such that the suggestion information is presented to the subject user using a subject communication device carried by the subject user among the plurality of communication devices.

7. An information presentation system that includes at least one home appliance having a communication function and a plurality of communication devices and is controlled by at least one control device,
wherein the at least one control device performs behavior prediction processing to predict a behavior using the at least one home appliance of a subject user who is a user of one of the plurality of communication devices operating the at least, one home appliance on the basis of operation information representing an operation content of an operation received by the at least one home appliance and an operation history of the at least one home appliance accumulated for each user of the plurality of communication devices, and suggestion information processing to generate suggestion information useful for the subject user to perform the behavior predicted in the behavior prediction processing such that the suggestion information is presented to the subject user using a subject communication device carried by the subject user among the plurality of communication devices.

8. The information presentation system according to claim 7,
wherein the plurality of communication devices include a server capable performing transmission and/or reception with the at least one home appliance and the plurality of communication devices,
the at least one control device is mounted in the server and further performs, in the suggestion information processing, processing to transmit the suggestion information that is generated to the subject communication device,
the at least one home appliance generates operation information representing an operation content of an operation received by the at least one home appliance and performs operation information processing to transmit the operation information that is generated to the server, and
the subject communication device performs suggestion information presentation processing to resent the suggestion information received from the at least one control device to the subject user.

9. A non-transitory computer readable medium recording a control program configured to cause a computer to function as the control device according to claim 1,
wherein the computer is caused to function as the presentation generation unit and the apparatus selection unit by the control program.

10. A control method of a control device configured to control an information presentation system including at least one home appliance having a communication function and a plurality of communication devices, the control method comprising:
performing behavior prediction processing to predict a behavior using the at least one horse appliance of a subject user who is a user of one of the plurality of communication devices operating the at least one home appliance on the basis of operation information representing an operation content of an operation received by the at least one home appliance and an operation history of the at least one home appliance accumulated each user of the plurality of communication devices; and
performing suggestion information processing to generate suggestion information useful for the subject user to perform the behavior predicted in the performing behavior prediction processing such that the suggestion information is presented to the subject user using a subject communication device carried by the subject user among the plurality of communication devices.
